(19) United States
(12) Patent Application Publication
(10) Pub. No.: US 2006/0247953 A1
(43) Pub. Date: Nov. 2, 2006

(54) Method of administrating insurance coverage

(76) Inventors: Robert Pollack, Orlando, FL (US); Frank L. Amodeo, Orlando, FL (US)

Correspondence Address: KENNETH F. PEARCE, 631 DENMARK DRIVE, DANVILLE, KY, 40422-2419, US

(21) Appl. No.: 11/115,587

(22) Filed: Apr. 27, 2005

(51) Int. Cl. G06Q 40/00; G07F 19/00

(52) U.S. Cl. 705/4; 705/30

(57) ABSTRACT

The present invention includes methods of administrating insurance coverage for a group of insured. A healthcare/risk manager is assigned to each insured to supervise and monitor the wellness of each insured. Among other things, bundled services can include healthcare and workers' compensation coverage.

### BACKGROUND OF THE INVENTION

1. Field of the Invention

Among other things, the present invention is related to methods of administrating insurance coverage for a group of insured. A healthcare/risk manager is assigned to each insured to supervise the wellness of each insured. After a claim event occurs, the healthcare/risk manager monitors the treatments and subsequent compliance by the claimant. Employers' are provided bundled services that can include healthcare and workers' compensation coverage.

2. Description of the Previous Art 1) US Published Patent Application 20020022982 A1-Cooperstone, et al. discloses a method and system for remotely managing business and employee administration function. Cooperstone provides an integrated system and business process for employee administration and human outsourcing to which both companies and their employees can subscribe. The '982 system is able to perform several types of administrative and human resource services, such as: payroll/administrative services, including payroll and tax filing, unemployment claims, COBRA and pre-tax plan administration; insurance services, including group health, property and casualty, and personal lines; retirement and savings plan administration, including 401K and IRA retirement savings plans, and deferred compensation plans; human resource services, including compliance material, employee development tools and advisory services; business network services, including discount procurement, purchasing cards, work share and e-mail; and employee services, including credit card and discount legal services.

2) US Published Patent Application 20010044735 A1-Colburn, et al. discloses an auditing and monitoring system for workers' compensation claims. The '735 system begins with an evaluation of the current status of an employer's total workers' compensation program—evaluating the current agreement between an insurer or Third Party Administrator (TPA) and the employer for claims management techniques, epic service specifications and required interaction between the two parties. After evaluation, modifications to the agreement are suggested to incorporate best practices and measurable goals into the existing agreement between the employer and the insurance service provider. These best practices and measurable goals provide the foundation by which the system evaluates the performance of the assigned adjusters, thus enhancing their performance level which ultimately creates a reduction in costs for the employer by decreasing direct and indirect costs.

The Coburn system provides a methodology whereby the employer's return to work policy or plan is evaluated. In the situations where the return to work policy or plan does not exist, the system assists in the implementation of such a plan. Where the return to work policy or plan exists, the plan is evaluated and return to work best practices and policies are recommended. Establishing an initial benchmark or goal for each claim allows the employers to gain a better understanding of the long-term potential liability for a particular case. This '735 methodology offers an Initial Recommendations Report to the employers within 72 hours of the initial claim report that allows employers to know up front the scope of the claim and its projected resolution. The initial report identifies high risk claimants and provides for an aggressive approach to workers' compensation claims that helps put the employee back to work and saves employers money and resources.

3) U.S. Pat. No. 6,381,576 B1-Gilbert enables a method, apparatus, and data structure for capturing and representing diagnostic, treatment, costs, and outcomes information in a form suitable for effective analysis and health care guidance. The Gilbert method is primarily directed toward a database structure that employs diagnostic and treatment information data structure that contains both clinical and financial information that permits effective filtering of CPT codes as to accuracy and appropriateness.

4) U.S. Pat. No. 6,484,144 B2-Martin, et al. enables a method and system for healthcare treatment planning and assessment. Martin is a method implemented in a data processing system for determining an appropriate treatment for a patient. The '144 system receives data reflecting a current state of the patient and computes a risk value that reflects a likelihood of the patient developing a disease, based on a subset of the diagnostic data. The Martin system then analyzes a proposed treatment plan, considering the computed risk value and the received diagnostic data.

5) U.S. Pat. No. 4,648,037-Valentino enables a method and apparatus for benefit and financial communication. The Valentino system allows an employee to access information regarding current employee benefits. In addition, the '037 method also provides a forecast function of future value of accumulated savings.

6) US Published Patent Application 20020059587 A1-Cofano, et al. discloses a method and apparatus for providing personalized services. The Cofano invention provides a method and apparatus allowing remote access to personalized services which reduces or eliminates the need for members or employees to expend valuable time personally visiting service providers, such as doctors, travel agents, and financial advisors.

### SUMMARY OF THE INVENTION

According to predetermined parameters, a coordinated benefits entity can control the communication dynamics between the professional employment organization, an employer, an insurance syndicate, the healthcare/risk managers, the representatives and the insured, beneficiaries or claimants. Employers are sold a bundle of services that includes the administration of healthcare and workers' compensation insurance policies. Due to actuarial data collected, the coordinated benefits entity can match the bundle of insurance services offered by one or more insurance carriers to best meet the needs of the employer. In an attempt to lower healthcare and workers' compensation expenses of the employer, healthcare risk/managers supervise the wellness of the insured prior to a claim activating event as well as monitor the status of any claimant after the occurrence of an insurance activating event. Healthcare/risk managers of the current method are highly trained medical personnel such as registered nurses.

The present invention is a method of, among other things, administrating health insurance and workers' compensation coverage for a group of insured. Generally, a professional employment organization administers the insurance coverage for an employer. The professional employment organization can also provide services such as payroll and tax accounting for the professional employment organization's co-employees. And within the scope of the present method, the professional employment organization or the coordinated benefits entity can also administer such services as retirement planning and other types of insurances and advice.

The group of insurance carriers, clearing house or syndicate provide a pool of insurance polices that can be tailor to the employer's needs. According to predetermined parameters, the coordinated benefits entity fashions one or more bundles that can be administrated by the professional employment organization. It is believed that the coordinated benefits entity can tailor a bundle of services that fits virtually any employer's insurance universe.

An aspect of the present invention is to provide wellness services for a group of insured.

Still another aspect of the present invention is to provide a method for managing an assortment of administrative, human resource and insurance responsibilities for a group of an employer's employees.

It is another aspect of the present invention to enable a method for providing one or more bundles of insurance, human resource and administrative services to one or more employers.

Yet another aspect of the present invention is to provide a method of collecting actuarial data regarding each of the insured, wherein the actuarial data relates to the insured wellness prior to participation in the current method and the insured's wellness after participation in the current method.

Still another aspect of the present invention is to provide a method of reducing healthcare and workers' compensation insurance costs of doing business for an employer.

Yet still another aspect of the present invention is to provide a healthier workplace for the employer's employees.

It is still another aspect of the present invention to provide a method of reducing employee turnover.

Still another aspect of the present invention is to provide an method of providing better healthcare for the insured.

It is still another aspect of the present invention to provide a method of reducing employee accidents at the workplace.

An embodiment of the present invention can be described as a method for managing an assortment of administrative, human resource and insurance responsibilities for a group of an employer's employees comprising the steps of: establishing a coordinated benefits entity responsible for coordinating said assortment of administrative, human resource and insurance responsibilities; relegating the administrative and insurance responsibilities to a professional employment organization or an insurance carrier; transferring select management functions from the employer to the professional employment organization such that the group of employees become co-employees of the professional employment organization; transferring management of health insurance and workers' compensation responsibilities from the employer to the insurance carrier, wherein the management of the health insurance and the workers' compensation responsibilities further comprise the steps of: issuing one or more policies, prior to an occurrence of an insurance claim activating event, assigning a healthcare/risk manager to supervise health status of each insured and on the occurrence of an insurance claim activating event, having the healthcare/risk manager monitor medical treatments and subsequent compliance by any claimant; and according to predetermined parameters established by the coordinated benefit entity, communicating said healthcare manager's observations to said employer.

Another embodiment of the present apparatus can be described as a method for providing one or more bundles of insurance, human resource and administrative services to one or more employers comprising the steps of: establishing a coordinated benefits entity responsible for coordinating sales of one or more of said bundles to one or more of employers, wherein the coordinated benefits entity further comprises: a clearing house for one or more insurance carriers; affiliating a plurality of representatives with the clearing house; having one or more of said representatives sell one or more bundles to one or more of employers; for each employer converting to one or more bundles, prior to converting to one or more bundles, having one or more representatives collect actuarial data regarding each converting employer's current insurance, human resource and administrative practices; and reporting the actuarial data to the coordinated benefits entity.

Yet another embodiment of the present invention and method can be described as a method of providing wellness services to a group of an employer's employees comprising the steps of: transferring select administrative functions from the employer to a professional employment organization; creating a risk underwriting syndicate of insurance carriers for underwriting risks of health insurance coverage and workers' compensation benefits; making health insurance and workers' compensation coverage available for the insured; establishing an entity for coordinating and integrating operations of the professional employment organization and the risk underwriting syndicate; administrating the health insurance coverage and the workers' compensation benefits through the professional employment organization; prior to an occurrence of any claim activating event, assigning a healthcare/risk manager to supervise health status of the insured; and upon an occurrence of a claim activating event, having the healthcare/risk manager monitor medical treatments and subsequent compliance by any of the insured.

In still another embodiment, the present invention can be described as a method of reducing costs of doing business for an employer comprising the steps of: affiliating one or more healthcare/risk managers with an entity: assigning the one or more healthcare/risk managers to regularly supervise persons insured by one or more insurance policies; after any filing of a claim by any claimant, having at least one of the healthcare/risk managers monitor medical treatments and subsequent compliance of any claimant filing a claim; coordinating interaction between one or more insurance carriers and the entity; and administrating the healthcare coverage and the workers' compensation coverage.

Yet another embodiment of the present device can be described as a method of reducing insurance costs of doing business for an employer comprising the steps of: affiliating one or more healthcare/risk managers with an entity; assigning one or more healthcare/risk managers to regularly supervise persons insured by one or more insurance policies; having one or more healthcare/risk managers encourage supervised persons to lead a generally healthier lifestyle; after any filing of a claim by any claimant against any policy, having at least one of the healthcare/risk managers monitor medical treatments and subsequent compliance of any claimant; and administrating the healthcare coverage and said workers' compensation coverage.

It is the novel and unique interaction of these simple elements which creates the methods of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is a depiction of an aspect of an embodiment of the present method.

FIG. 2 is a depiction of another aspect of an embodiment of the present method.

FIG. 3 is a depiction of another aspect of an embodiment of the present method.

### DESCRIPTION OF THE PREFERRED EMBODIMENTS

Although the disclosure hereof is detailed to enable those skilled in the art to practice the invention, the embodiments published herein merely exemplify the present invention.

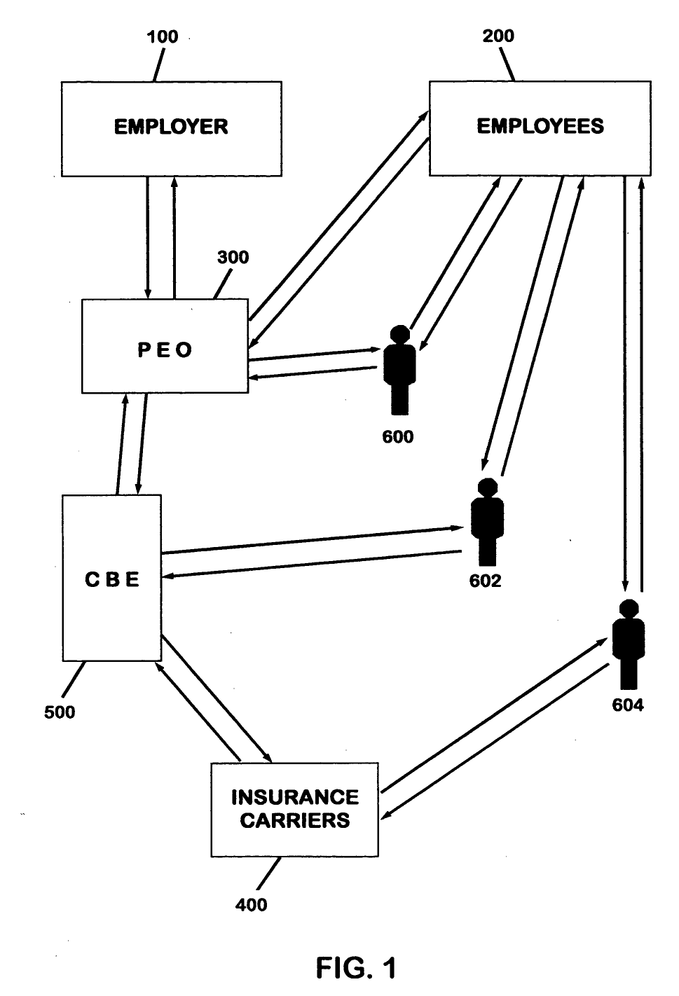

In the most general sense, a preferred embodiment of the present invention is a method of managing an assortment of administrative, human resource and insurance responsibilities for a group of employees. With a view toward FIG. 1, employer (100) employs group (200) of employees. When practicing one of the preferred embodiments, employer (100) engages professional employment organization (PEO) (300) to administer select employer responsibilities, such as payroll, tax accounting, health insurance plans and workers' compensation benefits. PEO (300) can be affiliated with Coordinated Benefits Entity (CBE) (500) that can be affiliated with one or more insurance carriers (400). In select preferred embodiments, PEO (300) and insurance carriers (400) can be integral components of CBE (500), while in other select preferred embodiments, CBE (500) is simply affiliated with one or more insurance carriers (400). In accordance with the present method and predetermined parameters, CBE (500) can control the pathways and direction for informational exchange between employer (100), PEO (300) and/or one or more insurance carriers or syndicate (400).

Due to economies of scale, PEO (300) can provide, among other things, the previously identified administrative services to employer (100) more economically than if employer (100) directly provided the services to group (200). In accordance with an embodiment of the present invention, group (200) employees become co-employees of PEO (300). And select embodiments of the present method can also have PEO (300) offering retirement, other insurances and financial services.

In many embodiments of the current method, employer (100) determines the scope of health care coverage made available to group (200) through PEO (300) and CBE (500) secures one or more insurance carriers (400) to underwrite the health care coverage selected by employer (100). In select embodiments, CBE (500) can make coverage available directly to employer (100) rather than through PEO (300). Insurance carriers (400) underwrite one or more health insurance polices for group (200) and all insured covered by the health insurance policy or policies. Within the scope of this preferred embodiment, PEO (300) also administers workers' compensation benefits for employer (100), and CBE (500) secures one or more insurance carriers or an insurance syndicate (400) to underwrite the workers' compensation care coverage. In select embodiments, CBE (500) can make workers' compensation coverage available directly to employer (100) rather than through PEO (300).

As shown in toward FIG. 1, healthcare/risk manager (600) is affiliated with PEO (300); healthcare/risk manager (604) is affiliated with one or more insurance carriers (400) and healthcare/risk manager (602) is affiliated with CBE (500). In other embodiments, all three healthcare/risk managers could be affiliated with a single component, or two of the healthcare/risk managers could be associated with the same component while the third healthcare/risk manager could be affiliated with one of the remaining two components. Importantly, preferred embodiments of the present invention can practice more or less than three healthcare/risk managers.

In accordance with the present invention, CBE (500) establishes parameters to govern the duties of healthcare/risk managers (600, 602 and 604) when interacting with group (200), any insured or claimant. Examples of such parameters include but are not limited to evaluating repetitive Monday morning absences by employees and reevaluation the patient's injury within seven days after consultation with a physician. Prior to an occurrence of a claim activating event, healthcare/risk managers of the present embodiment supervise group (200) and all insured to monitor wellness and health consequences associated with any insured's lifestyle. From time to time, one or more healthcare/risk managers can report on the status of any member of group (200) or any insured to PEO (300), insurance syndicate (400) or CBE (500), who may thereafter forward the healthcare/risk manager's observations to employer (100). As the need presents itself, one or more healthcare/risk managers (600, 602 and 604) can suggest to any insured changes to enhance a healthier lifestyle for the insured. Suggestions can include behaviors relating to diet, exercise, or other wellness issues. After an occurrence of a claim activating event, one or more healthcare/risk managers (600, 602 or 604) will monitor medical treatments and subsequent compliance for any healthcare claimant or workers' compensation claimant or beneficiary. Observations of the healthcare manager can be reported to PEO (300) and/or CBE (500). PEO (300) may also report the healthcare/risk manager's observations to employer (100). In accordance with the current preferred embodiment, the healthcare/risk manager can monitor medically related activities of the claimant—the monitoring can be face-to-face, telephonic, or by any other means acceptable in the art. Some examples of monitored activities include medical appointments, frequency of medical appointments, post-treatment therapies and compliance with the practitioner's treatment plan and prescription regimen. And when the need arises, the healthcare/risk manager can make suggestions to improve the claimant's treatment.

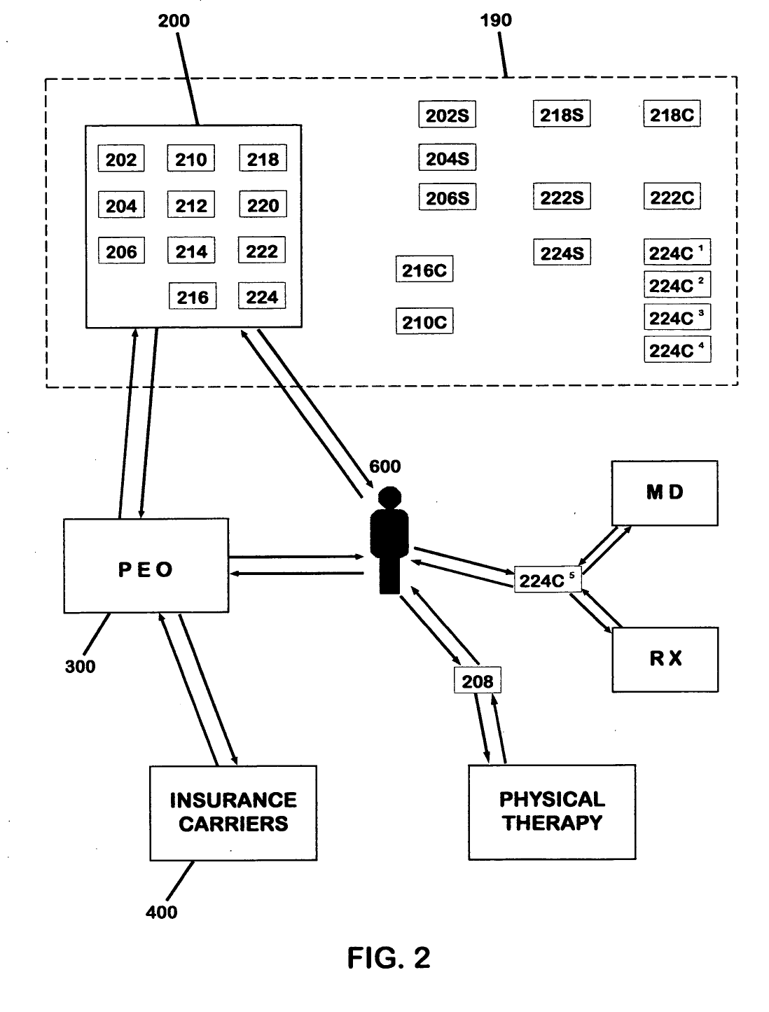

Among other things, FIG. 2 portrays insurance universe (190) of insured within the scope of the present invention. Group (200) of employer's (100) employees and PEO's (300) co-employees includes employees (202, 204, 206, 208, 210, 212, 214, 216, 218, 220, 222 and 224) are a part of insurance universe (190). Spouses 202S, 204S, 206S, 218S, 222S and 224S and children 210C, 216C, 218C, 222C, 224C¹, 224C², 224C³, 224C⁴ and 224C⁵ also form part of insurance universe (190). Only PEO's (300) co-employees (200-224) are covered under the workers' compensation policy, but the healthcare policy also covers family members of co-employees (200-224).

A simplistic representation of the supervising and monitoring functions of healthcare/risk manager (600) is depicted in FIG. 2. Periodically, healthcare/risk manager (600) supervises the wellness status of each member of insurance universe (190). As portrayed, healthcare/risk manager is supervising the wellness of co-employee (216). At the same time, healthcare/risk manager is monitoring the workers' compensation rehabilitation claim of co-employee (208) who is undergoing physical therapy. And healthcare/risk manager is also monitoring the status of co-employee's (224) health insurance claim for child (224C⁵) who is being treated by the pediatrician with antibiotics for a middle ear infection. In accordance with the present embodiment, healthcare/risk manager (600) reports the status of co-employee (208), co-employee (216) and child (224C⁵) to PEO (300). PEO (300) can relay the reports to insurance carriers (400) who may thereafter make suggestions to healthcare/risk manager (600) regarding the wellness or treatments of co-employee (208), co-employee (216) and child (224C⁵). Of course, healthcare/risk manager is a highly trained medical professional, such as a registered nurse or other equivalently trained medical professional, who can make suggestions to co-employee (208), co-employee (216) and child (224C⁵) independent from insurance carriers' (400) suggestions.

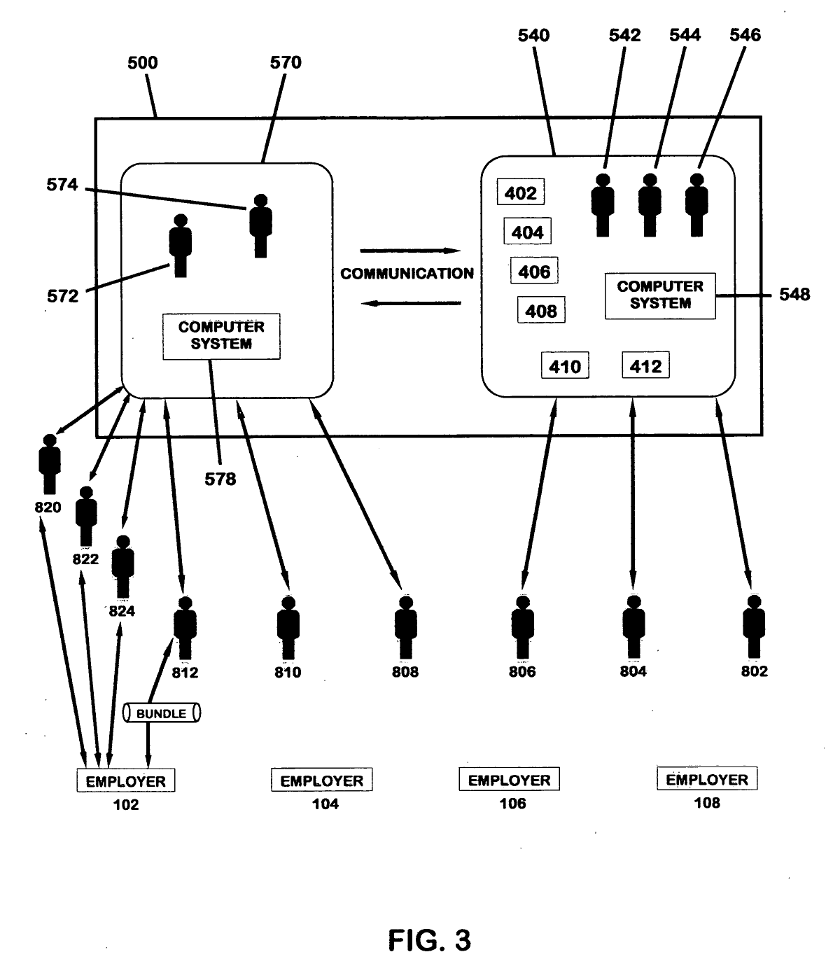

Another preferred embodiment of the present method is depicted in FIG. 3. In a general sense, this embodiment is a method of providing one or more bundles of insurance, human resources and administrative services to employers. Coordinated benefits entity (CBE) (500) includes a clearing house or syndicate (540) for one or more insurance carriers (402, 404, 406, 408, 410, 412) and coordinator (570). The plurality of insurance carriers (402, 404, 406, 408, 410, 412) underwrite policies that cover health insurance risks or workers' compensation risks or both. Clearing house (540) can be a person-to-person sales environment, a computer system or a combination of both a person-to-person (542, 544, 546) sales environment that includes a computer system (548). In a similar fashion, coordinator (570) can be one or more individuals (572 and 574), a computer system (578) or a combination of one or more individuals (572 and 574) and a computer system (578). Once of coordinator's (570) functions is to match the appropriate insurance carrier's policy to employer (100). Clearing house (540) and coordinator (570) intercommunicate in any manner acceptable in the art, i.e., person-to-person, computer-to-computer, person-to-computer or computer to person.

Representatives (802, 804 and 806) are affiliated with clearing house (540) and representatives (808, 810 and 812) are affiliated with coordinator (540). Any of representatives (802, 804, 806, 808, 810 and 812) can approach one or more employers (102, 104, 106 and 108) as allowed by law and offer to sell the employers one or more bundles of insurance, human resource and administrative services. Bundles of insurance, human resource and administrative services sold by the representatives (802, 804, 806, 808, 810 and 812) include a professional employment organization component, a health insurance coverage component and a workers' compensation coverage component. As shown in FIG. 3, representative (812) has sold a bundle of insurance, human resource and administrative services to employer (102).

Another group of representatives (820, 822 and 824) are also associated with CBE (500). Prior to providing the bundle of insurance or insurance policies, human resource and administrative services to converting employer (102), one or more representatives (820, 822 and/or 824) collect actuarial data from employer (102) regarding employer's current insurance, human resource and administrative practices. Examples of actuarial data that can be collected by one or more representatives (820, 822 and/or 824) include such observations as employees' Monday absenteeism rate, employees' compliances with treatment schedules and regimens, employees' compliances with treatment schedules and regimens and their corresponding absenteeism rate, employees' compliances with drug therapy and said employees' compliances with drug therapy and their corresponding absenteeism rate. Other types of actuarial data collected can relate to the insured's wellness prior to participation in the current method as well as the insured's wellness post participation in the current method.

Actuarial data collected by representatives (820, 822 and/or 824) can be subsequently incorporated into a database of computer system (578), which, among other things, can thereafter be utilized by coordinator (570) to better match insurance coverage for employers. Computer system (578) can also be utilized to select or partially select one or more policies for insuring health coverage and workers' compensation coverage. And depending on the programming selected by CEB (500), computer system (578) can also be used to assist with the management of the assortment of administrative, human resources and insurance responsibilities. In accordance with the present method, the collected actuarial data can be analyzed to, among other things, tailor bundles and/or other services for both employers and the insured.

Having disclosed the invention as required by Title 35 of the United States Code, Applicant now prays respectfully that Letters Patent be granted for his invention in accordance with the scope of the claims appended hereto.

What is claimed is:

1) A method for managing an assortment of administrative, human resource and insurance responsibilities for a group of an employer's employees; said method comprising the steps of:
a) establishing a coordinated benefits entity responsible for coordinating said assortment of administrative, human resource and insurance responsibilities for said group of said employer's employees;
b) relegating said administrative and insurance responsibilities to a professional employment organization or an insurance carrier, wherein said professional employment organization and said insurance carrier are affiliated with said coordinated benefits entity;
c) transferring select management functions from said employer to said professional employment organization such that said group of employees become co-employees of said professional employment organization, wherein said professional employment organization further assumes payroll and tax accounting responsibilities of said employer;
d) transferring management of health insurance and workers' compensation responsibilities from said employer to said insurance carrier; wherein said management of said health insurance and said workers' compensation responsibilities further comprise the steps of:
i) issuing one or more policies for insuring health coverage for any beneficiary of said health insurance;
ii) issuing one or more policies for insuring any potential recipient of said workers' compensation benefits;
iii) prior to an occurrence of an insurance claim activating event, assigning a healthcare/risk manager to supervise health status of each said beneficiary of said health insurance and any said potential recipient of said workers' compensation benefits;
iv) upon said occurrence of an insurance claim activating event, having said healthcare/risk manager monitor medical treatments and subsequent compliance by any claimant; and
v) reporting said healthcare/risk manager's observations to said professional employment organization of said coordinated benefit entity; and
e) according to predetermined parameters established by said coordinated benefit entity, communicating said healthcare manager's observations to said employer.

2) The method of claim 1 further comprising the steps of:
a) utilizing a computer system to at least partially select said one or more policies for insuring health coverage and workers' compensation coverage; and
b) using said computer system for assisting in management of said assortment of said administrative, human resources and insurance responsibilities.

3) The method of claim 2 wherein said professional employment organization and said insurance carrier are each integral parts of said coordinated benefits entity.

4) The method of claim 2 further comprising the step of prior to said occurrence of an insurance claim activating event, having one or more of representatives collect actuarial data regarding each said employer's insurance, human resource and administrative practices.

5) A method for providing one or more bundles of insurance, human resource and administrative services to one or more employers; said method comprising the steps of:
a) establishing a coordinated benefits entity responsible for coordinating sales of one or more of said bundles to one or more of said employers, wherein said coordinated benefits entity further comprises:
i) a clearing house for one or more insurance carriers; and
ii) at least one coordinator;
b) affiliating a plurality of representatives with said clearing house and said coordinator;
c) having one or more of said representatives sell one or more bundles to one or more of said employers, wherein each bundle sold further comprises:
i) a professional employment organization component;
ii) a health insurance coverage component; and
iii) a workers' compensation coverage component;
d) for each employer converting to one or more of said bundles, prior to converting to one or more of said bundles, having one or more of said representatives collect actuarial data regarding each said converting employer's current insurance, human resource and administrative practices; and
e) reporting said actuarial data to said coordinated benefits entity.

6) The method of claim 5 further comprising the step of collecting actuarial data regarding said employer's employees' work patterns for a period of one year prior to said employer converting to one or more of said bundles.

7) The method of claim 6 further comprising the steps of:
a) entering said actuarial data into one or more computer systems,
b) analyzing said actuarial data; and
c) utilizing said actuarial data to tailor said one or more bundles for each said converting employer.

8) The method of claim 7 wherein said actuarial data comprises:
a) said employees' Monday absenteeism rate;
b) said employees' compliances with treatment schedules and regimens;
c) said employees' compliances with treatment schedules and regimens and corresponding absenteeism;
d) said employees' compliances with drug therapy; and
e) said employees' compliances with drug therapy and corresponding absenteeism.

9) The method of claim 6 further comprising the steps of:
a) prior to a claim activating event, assigning a healthcare/risk manager to supervise wellness status of each potential beneficiary of said one or more bundles; and
b) subsequent to a claim activating event, having said healthcare/risk manager monitor medical treatments and ensuing compliance by any claimant.

10) The method of claim 9 further comprising the step of administrating said one or more bundles via a professional employment organization.

11) A method of providing wellness services to a group of an employer's employees; said method comprising the steps of:
a) transferring select administrative functions from said employer to a professional employment organization such that said group of employer's employees become co-employees of said professional employment organization;
b) creating a risk underwriting syndicate of insurance carriers for underwriting risks of health insurance coverage and workers' compensation benefits for said co-employees;
c) making health insurance coverage available for said co-employees and all insured covered under said health insurance coverage;
d) providing workers' compensation benefits to any claimant of said co-employees;
e) establishing an entity for coordinating and integrating operations of said professional employment organization and said risk underwriting syndicate;
f) administrating said health insurance coverage and said workers' compensation benefits through said professional employment organization;
g) prior to an occurrence of any claim activating event, assigning a healthcare/risk manager to supervise health status of said insured; and
h) upon an occurrence of a claim activating event, having said healthcare/risk manager monitor medical treatments and subsequent compliance by any of said insured.

12) The method of claim 11 further comprising the step of bundling health insurance coverage and workers' compensation benefits for said co-employees.

13) The method of claim 12 wherein said healthcare/risk manager is a registered nurse or the equivalent of a registered nurse.

14) A method of reducing costs of doing business for an employer, said method comprising the steps of:
a) affiliating one or more healthcare/risk managers with either:
i) one or more insurance carriers underwriting healthcare coverage and workers' compensation coverage; or
ii) one or more professional employment organizations; or
iii) said one or more insurance carriers and said one or more professional employment organizations;
b) assigning said one or more healthcare/risk managers to regularly supervise persons insured by one or more insurance policies, wherein said policies provide coverage for health insurance claimants and workers' compensation claimants, and wherein said healthcare/risk managers encourage supervised persons to lead a generally healthier lifestyle;
c) after any filing of a claim by any claimant, having at least one of said healthcare/risk managers monitor medical treatments and subsequent compliance of any claimant filing said claim;
d) establishing an entity for coordinating interaction between said one or more insurance carriers and said one or more professional employment organizations; and
e) administrating said healthcare coverage and said workers' compensation coverage as directed by said entity.

15) The method of claim 14, wherein each said healthcare/risk manager is a registered nurse or a similarly trained medical professional.

16) The method of claim 15 further the comprising the step of collecting actuarial data regarding each of said insured persons, wherein said actuarial data relates to:
a) each said insured's wellness prior to participation in said current method; and
b) each said insured's wellness post participation in said current method.

17) The method of claim 14 further comprising the step of affiliating said entity with an insurance syndicate including a plurality of insurance carriers for underwriting one or more insurance policies.

18) The method of claim 16, wherein said healthcare coverage and said workers' compensation coverage are administrated by a professional employment organization.

19) A method of reducing insurance costs of doing business for an employer, said method comprising the steps of:
a) affiliating one or more healthcare/risk managers with either:
i) one or more insurance carriers underwriting healthcare coverage and workers' compensation coverage; or
ii) an entity for administrating said healthcare coverage and said workers' compensation coverage; or
iii) said one or more insurance carriers and said entity;
b) assigning said one or more healthcare/risk managers to regularly supervise persons insured by one or more insurance policies issued by said one or more insurance carriers;
c) having said one or more healthcare/risk managers encourage supervised persons to lead a generally healthier lifestyle;
d) after any filing of a claim by any claimant against any policy, having at least one of said healthcare/risk managers monitor medical treatments and subsequent compliance of any claimant filing said claim; and
e) administrating said healthcare coverage and said workers' compensation coverage as directed by said entity.

20) The method of claim 19, wherein each said healthcare/risk manager is a registered nurse or a similarly trained medical professional.

21) The method of claim 20 further the comprising the step of collecting actuarial data regarding each of said insured persons, wherein said actuarial data relates to:
a) each said insured's wellness prior to participation in said current method; and
b) each said insured's wellness post participation in said current method.

22) The method of claim 21 further comprising the step of affiliating said entity with an insurance syndicate including a plurality of insurance carriers for underwriting one or more insurance policies.

23) The method of claim 22, wherein said healthcare coverage and said workers' compensation coverage are administrated by a professional employment organization.

24) The method of claim 22, wherein said healthcare coverage and said workers' compensation coverage are administrated by one or more of said plurality of insurance carriers.

25) A method for providing one or more bundles of insurance, human resource and administrative services to one or more employers; said method comprising the steps of:
a) establishing an entity responsible for coordinating sales of one or more of said bundles to one or more of said employers;
b) affiliating said entity with an insurance syndicate; and
c) selling one or more bundles to one or more employers, wherein each bundle sold further comprises:
i) a professional employment organization component;
ii) a health insurance coverage component; and
iii) a workers' compensation coverage component.

26) The method of claim 25 further comprising the steps of:
a) for each employer converting to one or more of said bundles, prior to converting to one or more of said bundles collecting actuarial data regarding each said converting employer's current insurance, human resource and administrative practices; and
b) reporting said actuarial data to said entity.

27) The method of claim 26 further comprising the steps of:
a) collecting actuarial data regarding said employer's employees' work patterns for a period of one year prior to said employer converting to one or more of said bundles; and
b) utilizing said actuarial data to tailor said one or more bundles for each said converting employer.

28) The method of claim 27 wherein said actuarial data comprises:
a) said employees' Monday absenteeism rate;
b) said employees' compliances with treatment schedules and regimens;
c) said employees' compliances with treatment schedules and regimens and corresponding absenteeism;
d) said employees' compliances with drug therapy; and
e) said employees' compliances with drug therapy and corresponding absenteeism.

29) The method of claim 28 further comprising the steps of:
a) prior to a claim activating event, assigning a healthcare/risk manager to supervise wellness status of each potential beneficiary of said one or more bundles; and
b) subsequent to a claim activating event, having said healthcare/risk manager monitor medical treatments and ensuing compliance by any claimant.
